(19) United States
(12) Patent Application Publication
(10) Pub. No.: US 2026/0013545 A1
(43) Pub. Date: Jan. 15, 2026

(54) METHODS AND APPARATUS FOR PRINTING AND COOKING FOOD PRODUCTS

(71) Applicants: David Lafond, Galesburg, MI (US); Daniel Lafond, Portage, MI (US); Christine O'Neil, Jupiter, FL (US)

(72) Inventors: David Lafond, Galesburg, MI (US); Daniel Lafond, Portage, MI (US); Christine O'Neil, Jupiter, FL (US)

(21) Appl. No.: 19/264,238

(22) Filed: Jul. 9, 2025

Related U.S. Application Data
(60) Provisional application No. 63/668,998, filed on Jul. 9, 2024.

(51) Int. Cl. A23P 20/20; B33Y 10/00; B33Y 30/00

(52) U.S. Cl. CPC A23P 20/20; B33Y 10/00; B33Y 30/00

(57) ABSTRACT

Apparatuses provide for 3D printing and simultaneously or nearly simultaneously cooking food products. Specifically, a 3D food printer apparatus is combined with a heat source, such as, for example, an infrared heat source or heat gun, a laser, or other heat generator, for cooking a 3D printed food product. Methods of using the same are further provided.

### CROSS-REFERENCE TO RELATED APPLICATIONS

The present invention claims priority to U.S. Provisional Pat. App. No. 63/668,998, titled “Methods and Apparatus for Printing and Cooking Food Products,” filed Jul. 9, 2025, which is incorporated herein by reference in its entirety.

### TECHNICAL FIELD

The present invention provides apparatuses for 3D printing and simultaneously or nearly simultaneously cooking food products. Specifically, the present invention comprises a 3D food printer apparatus and a heat source, such as, for example, an infrared heat source or heat gun, a laser, or other heat generator, for cooking a 3D printed food product. Methods of using the same are further provided.

### BACKGROUND

Traditional 3D food printers merely deposit uncooked/raw food matter onto a substrate, forming predetermined patterns. Similar to other methods of 3D printing, 3D-printed food consists of additive layers of edible material. While heat is often involved in the 3D-printed food process, it is not used to cook the resultant food but instead is typically used to soften the material for deposition during the additive methodology. Once a layer of the edible material is deposited, it typically congeals on a cold surface to stiffen the material to receive another layer thereof.

3D printed foods provide users with the ability to create interesting shapes while also controlling nutritional properties of the foods. In this way, many diverse types of foods having a limitless number of shapes and colors can be created, from meats, to doughs, to desserts. The parameters of the food desired to be created may be uploaded to the 3D printer, including shapes, materials, and colors, which may then use a plurality of diverse types of food materials of assorted colors to arrive at the final food.

Traditional 3D food printers are limited to depositing the materials on the substrate, known as the build plate, with the materials typically “curing” by chilling the same on the build plate. The curing step allows the materials to solidify sufficiently to use as base layers for subsequent additive printing of additional food layers. However, traditional 3D food printers do not provide sufficient heat to cook the food products created. As noted above, heat may be applied to soften edible materials for printing the same but are not used to change the nature or flavor of the resultant food product. Any cooking that may be accomplished is done after the food product is completed, or at stages during the additive process. But this typically requires removal of the 3D printed food product for cooking. And in the case of food products having additional layers printed thereon after cooking, the cooked 3D food product is typically removed from the 3D printer, cooked, and then inserted back onto the build plate for additional 3D printing.

A need, therefore, exists for improved apparatuses and methods for 3D printing food products. Specifically, a need exists for improved apparatuses and methods for printing 3D food products that allows for heating of individual additive layers of the food product during production thereof. Specifically, a need exists for improved apparatuses and methods for printing 3D food products that allows for cooking of the 3D food products without removal of the same from the 3D food printer.

In addition, a need exists for improved apparatuses and methods for printing 3D food products making the process faster and more efficient. Specifically, a need exists for improved apparatuses and methods that utilize one or more heat sources, such as infrared heat, heat guns, or lasers to cook individual layers simultaneously or nearly simultaneously upon printing the same on the build plate. Moreover, a need exists for improved apparatuses and methods for printing 3D food products that combines 3D food printing technology with food heating/cooking technology to cook food while 3D printing the same.

Further, a need exists for improved apparatuses and methods for printing 3D food products whereby a heat source is integrated directly into the 3D food printing process. Still further, a need exists for improved apparatuses and methods for printing 3D food products that eliminate post printing cooking processes, thereby reducing production time and labor costs. In addition, a need exists for improved apparatuses and methods for printing 3D food products that provide greater customization and control over final food products, including shape, texture, and flavor.

### SUMMARY OF THE INVENTION

The present invention provides apparatuses for 3D printing and simultaneously or nearly simultaneously cooking food products. Specifically, the present invention comprises a 3D food printer apparatus and a heat source, such as, for example, an infrared heat source or heat gun, a laser, or other heat generator, for cooking a 3D printed food product. Methods of using the same are further provided.

To this end, in an embodiment of the present invention, an apparatus for preparing a food product is provided. The apparatus comprises: a nozzle configured to extrude edible food materials onto a build plate additively; and a heat source, wherein the heat source heats the extruded edible food material from the nozzle thereby cooking the extruded edible food material.

In an embodiment, the heat source heats the edible food material after a layer of the edible food material is extruded onto the build plate and before a next layer of food material is extruded onto the build plate.

In an embodiment, the heat source heats the edible food material as the edible food material is extruded from the nozzle onto the build plate.

In an embodiment, the heat source is a laser.

In an embodiment, the heat source provides convective heat to the extruded edible food material.

In an embodiment, the heat source provides infrared heat to the extruded edible food material.

In an embodiment, the edible food material is extruded from one of a plurality of food material extrusion modules.

In an embodiment, the heat source is separate from the extruder head but selectable by the extruder head for adding heat to the extruded edible food material after the edible food material is extruded onto the build plate.

In an embodiment, the heat source is integrated with the extruder head for adding heat to the extruded edible food material.

In an embodiment, the heat source is integrated with the extruder head for adding heat to the extruded edible food material, and further wherein the edible food material is extruded from one of a plurality of food material extrusion modules.

In an alternate embodiment of the present invention, a method of forming and cooking edible food products is provided. The method comprises the steps of: providing an apparatus for preparing a food product comprising an extruder head and a nozzle configured to extrude edible food materials onto a build plate additively and a heat source, wherein the heat source heats the extruded edible food material from the nozzle thereby cooking the extruded edible food material; extruding a first layer of edible food material from the extruder head and the nozzle onto the build plate; heating the first layer of edible food material with the heat source; extruding a second layer of edible food material from the extruder head and the nozzle onto the build plate; and heating the second layer of edible food material with the heat source.

In an embodiment, the heat source is a laser.

In an embodiment, the heat source provides convective heat to the extruded edible food material.

In an embodiment, the heat source provides infrared heat to the extruded edible food material.

In an embodiment, the heat source is integrated with the extruder head or separate from the extruder head but selectable by the extruder head for heating the first and second layers of edible food material.

In yet another alternate embodiment of the present invention, a method of forming and cooking edible food products is provided. The method comprises the steps of: providing an apparatus for preparing a food product comprising an extruder head and a nozzle configured to extrude edible food materials onto a build plate additively and a heat source, wherein the heat source heats the extruded edible food material from the nozzle thereby cooking the extruded edible food material; extruding edible food material from the extruder head and the nozzle on the build plate; and heating the extruded edible food material as it exits the nozzle on the build plate with the heat source.

In an embodiment, the heat source is a laser.

In an embodiment, the heat source provides convective heat to the extruded edible food material.

In an embodiment, the heat source provides infrared heat to the extruded edible food material.

In an embodiment, the heat source is integrated with the extruder head.

It is, therefore, an advantage and objective of the present invention to provide improved apparatuses and methods for 3D printing food products.

Specifically, it is an advantage and objective of the present invention to provide improved apparatuses and methods for printing 3D food products that allows for heating of individual additive layers of the food product during production thereof.

Specifically, it is an advantage and objective of the present invention to provide improved apparatuses and methods for printing 3D food products that allows for cooking of the 3D food products without removal of the same from the 3D food printer.

In addition, it is an advantage and objective of the present invention to provide improved apparatuses and methods for printing 3D food products making the process faster and more efficient.

Specifically, it is an advantage and objective of the present invention to provide improved apparatuses and methods that utilize one or more heat sources, such as infrared heat, heat guns, or lasers to cook individual layers simultaneously or nearly simultaneously upon printing the same on the build plate.

Moreover, it is an advantage and objective of the present invention to provide improved apparatuses and methods for printing 3D food products that combines 3D food printing technology with food heating/cooking technology to cook food while 3D printing the same.

Further, it is an advantage and objective of the present invention to provide improved apparatuses and methods for printing 3D food products whereby a heat source is integrated directly into the 3D food printing process.

Still further, it is an advantage and objective of the present invention to provide improved apparatuses and methods for printing 3D food products that eliminate post printing cooking processes, thereby reducing production time and labor costs.

In addition, it is an advantage and objective of the present invention to provide improved apparatuses and methods for printing 3D food products that provide greater customization and control over final food products, including shape, texture, and flavor.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a 3D food printer with a separate laser module for heating food printed therefrom in an embodiment of the present invention.

FIG. 2 illustrates a 3D food printer with an integrated laser module or forced air heater for heating food printed therefrom in an embodiment of the present invention.

FIG. 3 illustrates a 3D food printer with an extruder head with an integrated laser module for heating food material during extrusion thereof in an embodiment of the present invention.

FIG. 4 illustrates a 3D food printer with an extruder head with an integrated forced air heater for heating food material during extrusion thereof in an embodiment of the present invention.

### DETAILED DESCRIPTION OF THE PRESENTLY PREFERRED EMBODIMENTS

The present invention provides apparatuses for 3D printing and simultaneously or nearly simultaneously cooking food products. Specifically, the present invention comprises a 3D food printer apparatus and a heat source, such as, for example, an infrared heat source or heat gun, a laser, or other heat generator, for cooking a 3D printed food product. Methods of using the same are further provided.

In an embodiment of the present invention, a 3D food printer includes a heat gun integrated therein. The heat gun comprises one or a set of a plurality of heating elements strategically positioned to focus heat generated thereby, in the nature of infrared heat and/or convective heat, at the extrusion nozzle of the 3D food printer. The one or more heating elements may be capable of generating and maintaining a temperature suitable for cooking several types of food materials, including but not limited to, doughs, batters, protein-based pastes, vegetable purees, and other like malleable and printable food materials. Temperature sensors may be integrated into the heat gun to monitor and control the temperature of the cooking surface in real-time, ensuring precise control over the cooking process.

In an alternate embodiment of the present invention, a laser may be utilized as an alternative heat source to apply an alternative cooking technique to the printed food. The laser may be focused on the product stream through the use of fiber optics, for example, although the present invention should not be limited as described herein. The focus of the laser on the food product stream may enable rapid heating of the food stream as the food is deposited from the nozzle, providing precise control of energy used. The laser may be configured to deliver controlled heating of the food material.

As a food item is printed using the 3D food printer, a heat source, such as the integrated heat gun or laser, as described above, may be activated to cook the deposited food material as it emerges from the extrusion nozzle, rather than cooling and “curing” the food material as is done traditionally. One or more temperature sensors may continuously monitor the cooking surface (i.e., the build plate) to ensure uniform heat distribution and to prevent overcooking of the same. Alternatively, the heat source, whether laser or heat gun, may be disposed on each layer of food that may be deposited. Therefore, the food item may have a layer printed, followed by cooking the entirety of the layer, followed by deposition of a second layer, cooking the second layer with the heat source, and so forth.

When a food item is printed using the 3D food printer and heated using a laser, as described above, the fiber optics may focus the energy on the food stream to rapidly cook the food and achieve a desired texture.

### EXAMPLES

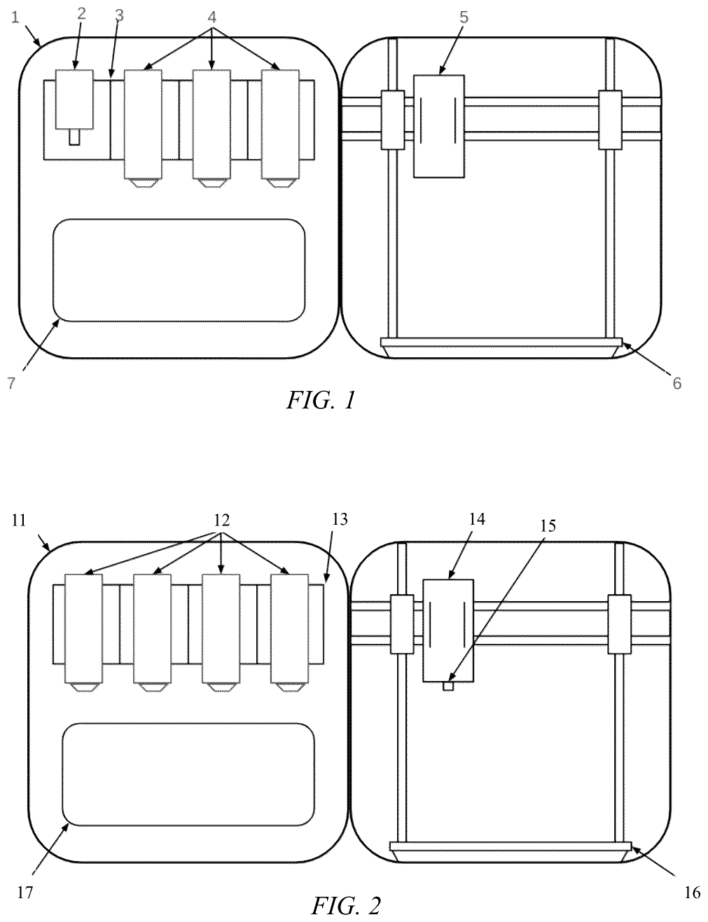

An example of the process was tested with a Foodini® 3D food printer that utilizes multiple food material modules, which are stainless steel cartridges filled with different food materials that can be selected for printing, as illustrated in FIG. 1. Specifically, the food printer may have a door 1 having a laser module 2, a door mounted module holder 3, and a plurality of food material extrusion modules 4. The food printer further may have an extruder 5 that selects one of the material extrusion modules 4 for printing food on a build plate 6. The laser module 2 may be used for heating material after it has been extruded by the main extruder head 5. This may be done either by integrating a laser module into the body of the main extruder head or as a separate module 2 that can be picked up by the extruder head, just as material extrusion modules are picked up and used.

Extrusion may happen one layer at a time, with the material extrusion module loaded in the main extruder head, a layer of material may be placed on the build plate, then the printer may return the material extrusion module 4 to the door mounted module holder 3 and the laser module 2 may be loaded on the extruder head 5, which then may go over the previously extruded layer on the build plate 6 while activating the laser module to heat the material. The door 1 may further have a laser frequency blocking window for safety.

Example laser settings used for this method:
i. 100% laser power (10 W laser module)
ii. 1000 mm/min speed
iii. 100 mm distance from top of material to laser output (this puts the laser spot out of focus with a spot size of several millimeters to heat a wide diameter of extruded material
iv. Approximately 1 mm material thickness

All of the above settings may be adjusted in order to heat material more slowly, which may be useful to reduce burning, change the spot size of the laser, which may heat a smaller or larger diameter of material and reduce intensity of heat, and increase or reduce the amount of time that the laser is energized on one particular point of material

Too thin of an extruded material layer may mean that laser energy is not absorbed very well, so a material thickness of at least 1 mm is preferred.

Alternatively, the same method above may be completed without a separate laser module for the extruder head to load. In this embodiment, as illustrated in FIG. 2, a door 11 may have a plurality of material extrusion modules 12 mounted to a door mounted module holder 13, and a laser frequency blocking window 17. A laser module 15 may be integrated into an extruder head 14 itself so no separate module needs to be loaded. Extrusion may still happen one layer at a time, with the material extrusion module loaded in the main extruder head 14. A layer of material may be placed on the build plate 16, then the extruder head 14 may align the integrated laser module 15 over the extruded material, which then may go over the previously extruded layer while activating the laser module 15 to heat the material.

These same concepts may apply to a forced air heater (such as, for example, a heat gun or similar concept) as well, where a separate heating module or integrated heating module may be used in place of the separate or integrated laser modules, as described above.

Exemplary settings for heater used for this embodiment:
i. 600° C. output;
ii. 5 mm output diameter;
iii. 500 mm/min print speed;

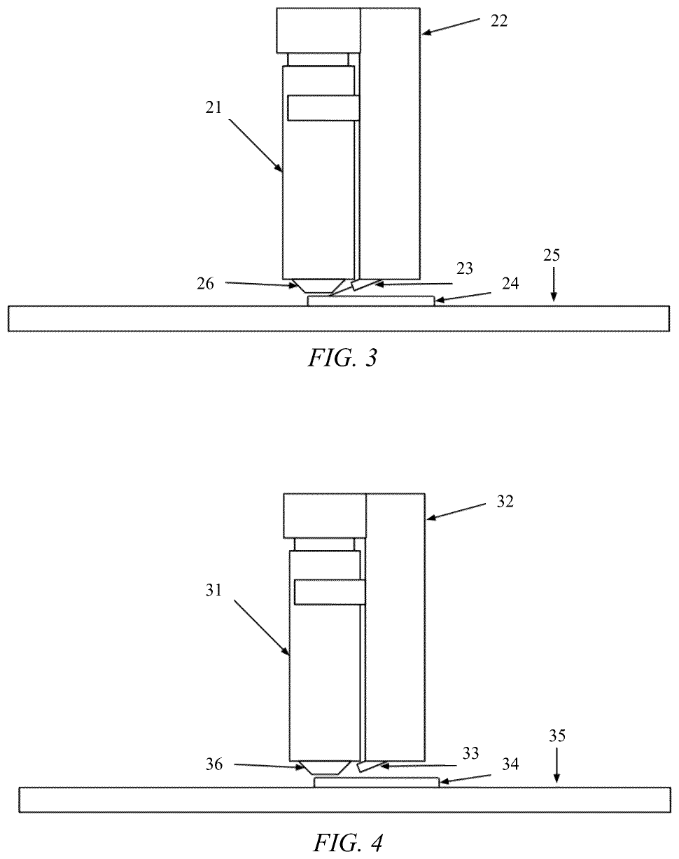

A benefit of the laser module or forced air heater being integrated into the extruder head, as illustrated in FIG. 3, which illustrates an extruder head with an integrated laser module for heating food material during extrusion thereof, is that heating of material may be done during extrusion of the layer instead of after the whole layer is extruded. This may be possible if the laser output or hot air output is aimed directly at the output of the material extruder nozzle. FIG. 3 illustrates a food printer wherein a material extrusion module 21 may be selected by an extruder head 22, with an integrated laser module 23 aimed at the extrusion output of the material extrusion module 21. Extruded material 24 may be extruded from the material extrusion module 21 through an extruder nozzle 26 on a build plate 25. As the extruded material 24 is extruded onto the build plate 25, the integrated laser module 23 aimed at the extrusion output thereof may heat and cook the extruded material.

Likewise, FIG. 4 illustrates an extruder head with an integrated forced air heater for heating the food material during extrusion wherein a food printer wherein a material extrusion module 31 may be selected by an extruder head 32, with an integrated forced air heater 33 aimed at the extrusion output of the material extrusion module 31. Extruded material 34 may be extruded from the material extrusion module 31 through an extruder nozzle 36 on a build plate 35. As the extruded material 34 is extruded onto the build plate 35, the integrated forced air heater 33 aimed at the extrusion output thereof may heat and cook the extruded material.

Use of a laser module, as described above, may provide an additional feature in that it may be used to produce graphics and text on the extruded material. Laser height may be lowered to reduce line thickness of marks that may be produced. In the event that lowering the laser height may increase the amount of laser energy on that point, increasing speed of travel or decreasing laser power output may decrease the laser energy, which may reduce burning. To produce marking on material, a slightly slower speed or higher power output from what was used to cook material may be used to make marks darker than the cooked material.

Additionally, a camera integrated in the printer may be used to monitor and analyze material to detect underheating or overheating. Output settings may be adjusted accordingly. An integrated infrared temperature sensor may monitor the temperature of extruded material as it is heated to accomplish similar results, thereby allowing adjustments to temperature. This method may be used to determine whether adjustments are necessary, instead of determining visually.

Generally, any heat source, such as, for example, the aforementioned heat gun and/or the laser, may be capable of producing fully cooked food items having customized shapes, textures, and flavors. As noted above, the food materials may be heated immediately upon ejection from the nozzle so that the food materials are cooked simultaneously or nearly simultaneously upon ejection and/or deposition from the nozzle. Alternatively, individual layers may be fully deposited and cooked using the heat gun and/or laser, or other heat source, prior to depositing additional layers thereon. Thus, each layer may be individually heated and cooked prior to deposition of the next layer.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An apparatus for preparing a food product comprising:
a nozzle configured to extrude edible food materials onto a build plate additively; and
a heat source, wherein the heat source heats the extruded edible food material from the nozzle thereby cooking the extruded edible food material.

2. The apparatus of claim 1 wherein the heat source heats the edible food material after a layer of the edible food material is extruded onto the build plate and before a next layer of food material is extruded onto the build plate.

3. The apparatus of claim 1 wherein the heat source heats the edible food material as the edible food material is extruded from the nozzle onto the build plate.

4. The apparatus of claim 1 wherein the heat source is a laser.

5. The apparatus of claim 1 wherein the heat source provides convective heat or infrared heat to the extruded edible food material.

6. The apparatus of claim 1 further comprising:
a laser module, wherein the laser module comprises a laser configured to mark indicia on the edible food material.

7. The apparatus of claim 1 wherein the edible food material is extruded from one of a plurality of food material extrusion modules.

8. The apparatus of claim 1 wherein the heat source is separate from the extruder head but selectable by the extruder head for adding heat to the extruded edible food material after the edible food material is extruded onto the build plate.

9. The apparatus of claim 1 wherein the heat source is integrated with the extruder head for adding heat to the extruded edible food material.

10. The apparatus of claim 1 wherein the heat source is integrated with the extruder head for adding heat to the extruded edible food material, and further wherein the edible food material is extruded from one of a plurality of food material extrusion modules.

11. A method of forming and cooking edible food products comprising the steps of:
providing an apparatus for preparing a food product comprising an extruder head and a nozzle configured to extrude edible food materials onto a build plate additively and a heat source, wherein the heat source heats the extruded edible food material from the nozzle thereby cooking the extruded edible food material;
extruding a first layer of edible food material from the extruder head and the nozzle onto the build plate;
heating the first layer of edible food material with the heat source;
extruding a second layer of edible food material from the extruder head and the nozzle onto the build plate; and
heating the second layer of edible food material with the heat source.

12. The method of claim 11 wherein the heat source is a laser.

13. The method of claim 11 further comprising the step of:
marking indicia on the edible food material with a laser.

14. The method of claim 11 wherein the heat source provides convective heat or infrared heat to the extruded edible food material.

15. The method of claim 11 wherein the heat source is integrated with the extruder head or separate from the extruder head but selectable by the extruder head for heating the first and second layers of edible food material.

16. A method of forming and cooking edible food products comprising the steps of:
providing an apparatus for preparing a food product comprising an extruder head and a nozzle configured to extrude edible food materials onto a build plate additively and a heat source, wherein the heat source heats the extruded edible food material from the nozzle thereby cooking the extruded edible food material;
extruding edible food material from the extruder head and the nozzle on the build plate; and
heating the extruded edible food material as it exits the nozzle on the build plate with the heat source.

17. The method of claim 16 wherein the heat source is a laser.

18. The method of claim 16 further comprising the step of:
marking indicia on the edible food material with a laser.

19. The method of claim 16 wherein the heat source provides convective heat or infrared heat to the extruded edible food material.

20. The method of claim 16 wherein the heat source is integrated with the extruder head.
